(19) United States
(12) Patent Application Publication
(10) Pub. No.: US 2019/0034802 A1
(43) Pub. Date: Jan. 31, 2019

(54) Dimensionality reduction in Bayesian Optimization using Stacked Autoencoders

(71) Applicant: Siemens Aktiengesellschaft, Munich (DE)

(72) Inventors: Prashanth Harshangi, New Haven, CT (US); Ioannis Akrotirianakis, Princeton, NJ (US); Amit Chakraborty, East Windsor, NJ (US)

(21) Appl. No.: 15/662,917

(22) Filed: Jul. 28, 2017

(51) Int. Cl. G06N 3/08; G06F 17/11

(52) U.S. Cl. CPC G06N 3/088; G06F 17/11

(57) ABSTRACT

The present embodiments relate to reducing the input dimensions to a machine-based Bayesian Optimization using stacked autoencoders. By way of introduction, the present embodiments described below include apparatuses and methods for pre-processing a digital input to a machine-based Bayesian Optimization to a lower the dimensional space of the input, thereby lowering the bounds of the Bayesian optimization. The output of the Bayesian Optimization is then projected back into the original dimensional space to determine input and output values in the original dimensional apace. As such, the optimization is performed by the machine in a lower dimension using the stacked autoencoder to constrain the input dimensions to the optimization.

### BACKGROUND

In machine optimization as opposed to human performed mathematics, black-box optimization problems involve optimizing a simulation where the underlying function defining the simulation does not have an analytical or algebraic formula available. Based on the simulation, the black-box function is optimized using a sets of input values and the corresponding outputs derived from the simulation. Optimizing the simulation is difficult without the underlying function, as derivatives of the function are not available and the optimization relies on the input and output pairs to define the simulation. Black-box optimization problems arise in many areas of engineering and mathematics, such as in designing equipment optimized for certain design requirements, including chemical reaction processes, turbine efficiency problems, wind farm layout design, design involving complex partial differential equations (PDEs), aerospace design problems, etc.

Bayesian Optimization (BO) is a method used to optimize a nonlinear function ƒ(x) when the function is computationally expensive to evaluate. BO optimizes input values of the function when derivatives are not available, and may be used when input/output pairs for the unknown function are noisy. In addition to finding an optimum (i.e., a minimum or a maximum) of the black-box function, BO derives other characteristics of the function, such as for sensitivity analysis of the black-box function or identifying other points of interest apart from the global optimum. To optimize a black-box function ƒ(x), BO constructs a prior distribution about ƒ(x) based on input and output values of the function, and updates the distribution iteratively with new values derived by the BO. For example, new input values to black-box function are derived from the prior distribution of input and output values, in an acquisition function optimization. The new input values are then used to evaluate the black-box function to generate a new output to be included in the prior distribution of values for a next iteration of the optimization. The process is repeated until a termination criteria is met (e.g., the input values to the black-box function are optimized within a desired threshold, or a maximum number of iterations, specified by the user, have been reached).

BO performs well in problems for functions with a small number of dimensions (e.g., less than 10 unknown variables), but does not scale well to higher dimensions. Higher dimension black-box functions prevent BO from being used in many applications. In order to use BO with higher dimension black-box functions, the optimization problem may be restricted by assumptions of the black-box function (e.g., the nature of the function). For example, the black-box function may be assumed to have an active lower subspace. In applying this assumption, the active lower subspace is unknown, but the dimension of the lower subspace is known. Random embedding in the lower subspace may then be used to make the optimization process less time consuming. However, knowing the dimension of the lower subspace is often an impractical assumption.

### SUMMARY

The present embodiments relate to reducing the input dimensions to a machine-based Bayesian Optimization using stacked autoencoders. By way of introduction, the present embodiments described below include apparatuses and methods for pre-processing a digital input to a machine-based Bayesian Optimization to a lower the dimensional space of the input, thereby lowering the bounds of the Bayesian optimization. The output of the Bayesian Optimization is then projected back into the original dimensional space to determine input and output values in the original dimensional apace. As such, the optimization is performed by the machine in a lower dimension using the stacked autoencoder to constrain the input dimensions to the optimization.

In a first aspect, a method for reducing dimensions of an input in a black-box optimization is provided. The method includes generating a first plurality of inputs and a plurality of outputs corresponding to the first plurality of inputs by evaluating a black-box function characterizing an equipment component. The method also includes training an autoencoder with the first plurality of inputs and encoding the first plurality of inputs to generate a second plurality of inputs with the trained autoencoder. The second plurality of inputs includes fewer dimensions than the first plurality of inputs. The method further includes performing an optimization using the second plurality of inputs and the plurality of outputs, and decoding an output of the optimization into dimensions of the first plurality of inputs with the trained autoencoder.

In a second aspect, a system is provided for reducing dimensions of an input in an optimization. The system includes a memory configured to store a plurality of input vectors and a plurality of outputs for an unknown function that characterizes requirements for equipment design. The system also includes a processor configured to receive the plurality of input vectors and the plurality of outputs from the memory, and to reduce a dimensional space of the plurality of input vectors with a stacked autoencoder. The processor is also configured to perform a Bayesian Optimization based on the reduced dimensional space of the plurality of input vectors and the plurality of outputs, and to project an output of the Bayesian optimization into the dimensional space of the plurality of input vectors using the stacked autoencoder.

In a third aspect, a method is provided for reducing input dimensions for optimizing an unknown function characterizing an equipment component. The method includes generating a plurality of input vectors and a plurality of outputs based on an unknown function, and extracting a plurality of feature vectors from the plurality of input vectors. The feature vectors are represented by fewer dimensions than the input vectors with a stacked autoencoder. The method also includes optimizing parameters of the extracted feature vectors based on the plurality of outputs, and decoding the optimized parameters of the extracted feature vectors with the stacked autoencoder to generate parameters for an optimized input vector.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 illustrates a block diagram of an example of an autoencoder.

FIG. 2 illustrates a flowchart diagram of an embodiment of a method for reducing dimensions of an input in a black-box optimization.

FIG. 3 illustrates an embodiment of a system for reducing dimensions of an input in an optimization.

FIG. 4 illustrates a flowchart diagram of an embodiment of a method for reducing input dimensions for optimizing an unknown function.

### DETAILED DESCRIPTION OF EXEMPLARY EMBODIMENTS

The present machine optimization embodiments provide for reducing the dimensionality of large black-box optimization using a stacked autoencoder (SAE), then using Bayesian Optimization (BO) to locate an optimal solution for the black-box function at the lower dimension. The SAE reduces the dimensionality of the black-box function, increasing the efficiency of the BO. SAE, such as a stacked denoising autoencoder, are a framework in Deep Learning for finding a lower dimensional space of an input, while preserving the characteristics of the input at the original higher dimensional space (e.g., where the black-box function is originally defined). Instead of applying BO on the original higher dimensional space, the BO is applied to the lower dimensional space defined by the encoding layers of the SAE. The BO finds an optimal solution for the black-box function at the lower dimensional space, then the solution is decoded back to the original higher dimension using the decoding layers of the SAE. Reducing the dimensional space simplifies the BO, allowing BO to be used on a high dimensional black-box function. The reduced dimensional space also contains fewer local optima than the original high dimensional space (e.g., is smoother), therefore further increasing the performance of the Bayesian Optimization.

Bayesian Optimization (BO) is a technique for determining the optimal solution to simulation-based optimization problems, such as when the underlying function of the simulation is unknown (e.g., black-box optimization problems). BO uses Gaussian Processes (GP) to determine a probabilistic model of the unknown function using approximation functions. One of the drawbacks of BO is that the BO cannot efficiently perform an optimization when the number of dimensions/variables increases (e.g., above 10 dimensions). Higher dimensional optimization problems require a prohibitively long CPU processing time to converge. By reducing the input dimensions of the BO using the SAE from a different form of machine optimization, the BO can efficiently optimize a high dimensional black-box function.

As discussed above, a machine optimization with BO may be used to in many areas of engineering design, such as for designing a wind turbine. In the wind turbine example, the size and shape of the turbine blade are optimized to maximize the energy output efficiency of the turbine, such as by running many simulations of the turbine with different input values defining the size and shape of the blade. The turbine is simulated as a black-box function. For example, the black-box function for the turbine includes a high number of input variables (e.g., represented by a multi-dimensional input vector x) that affect an output of the simulation (e.g., an energy output efficiency value y). Simulations are performed with the black-box function to generate corresponding input and output pairs representative of the blade of the wind turbine.

Following with this example, the wind turbine optimization problem above is set up as a black-box optimization as follows. The response of the black-box function y is optimized based on input vectors x, represented by equations (1):

ƒ:D⊂ [symbol] ⁿ→

[symbol]

y=ƒ(x); x∈ [symbol] ⁿ (1)

where D⊆ [symbol] ⁿ is the n-dimensional design space and ƒ(x) is the black-box function. The input-output samples of the function ƒ(x) are available at certain distinct points, represented by (2):

X={x₁, . . . ,x_{N}}

Y={y₁, . . . ,y_{N}} (2)

N represents the number of initial input-output samples, and each point x is a multivariate vector. The goal of Black-Box optimization is to find an optimized input x* for the unknown function ƒ(x), represented by (3):

$${x}^{*} = arg f ( x ) \qquad ( 3 )$$

As such, for the wind turbine optimization problem, the BO builds a probabilistic model for the black-box function ƒ(x), and uses this probabilistic model to select the next point in D where ƒ(x) will be evaluated. The next point D represents the multi-dimensional input vector for x* with optimized parameters of the size and shape of the turbine blade. The next point D is used to sample the black-box function ƒ(x) to generate an output based on the optimized variables x* to generate an optimized output y* representing the energy output efficiency of the turbine. In an iterative process, the next point D (x*, y*) is included as another distinct point in the input-output samples of the black-box function ƒ(x) used in a next iteration of the optimization by the BO. After each iteration, D (x*, y*) moves closer to the optimal input for the black-box function, with x* eventually defining the optimal size and shape of the blade and y* representing the optimal output efficiency of the turbine.

The BO uses Gaussian Processes (GP) to determine approximation functions as a probabilistic model for the unknown function ƒ(x) governing the simulation. The GP is provided as a surrogate model for output of the unknown function ƒ(x). For example, using a GP with the finite set of points (X, Y) discussed above at (2), a multivariate Gaussian distribution can be modeled in any n-dimensional real space Rⁿ. The mean and covariance of the Gaussian distribution are then calculated, dependent on the kernel used to define the covariance function. For example, a squared exponential kernel is used. Other kernels may be used, chosen depending on the optimization problem. Using the squared exponential kernel, a mean function of the GP is specified as (4):

m:X→R (4)

A covariance kernel of the GP is specified as (5):

K:X×X→R (5)

Then, given the finite set of points (x₁ₓ), where xᵢ∈ [symbol] ⁿ, the covariance function is written as in (6), where K is the covariance matrix:

ƒ(x₁ₓ)≈N(m(x₁ₓ,K(x₁ₓ,x₁ₓ))) (6)

The analytical tractability of the GP provides the joint distribution for the new point x*, as a posterior/predictive distribution. For example, if yᵢ represents the output of the function yᵢ=ƒ(xᵢ), then the joint distribution of the new point x* is normally distributed with the calculated mean and variance, represented as (7):

$$[ \begin{matrix}{f}_{1 st} \\ {f}^{*}\end{matrix} ] = 𝒩 ( [ \begin{matrix}m ( {x}_{1 : t} ) \\ {m}^{*}\end{matrix} ] , [ \begin{matrix}K ( x , x ) & k ( x , {x}^{*} ) \\ k ( x , {x}^{*} ) & k ( {x}^{*} , {x}^{*} )\end{matrix} ] ) \qquad ( 7 )$$

Therefore, using (8) above, the posterior mean and variance for any given point x* is calculated as (8):

ƒ*|D,x*˜N(μx*|D),σ(x*|D)) (8)

where D is the given input-output data values. The predictive mean and covariance is calculated as (9):

μ(x*|D)=k(x*,x₁ₓ)K(x₁ₓ,x₁ₓ)⁻¹y₁ₓ

σ(x*|D)=k(x*,x*)−k(x*,x₁ₓ)K(x₁ₓ,x₁ₓ)⁻¹k(x₁ₓ,x*) (9)

After the analytical forms of the posterior mean and variance are calculated, an optimal point may be calculated. To calculate the optimal point, an acquisition function of the GP is constructed for the optimization. GPs update the probabilistic model as new data becomes available iteratively. For example, a next point is determined for evaluation with the black-box function ƒ(x). To determine the next point, an acquisition function is defined for regions in the design space having high-variance or high mean regions.

The acquisition function guides the optimization process to determine the next point for updating the GP. Many different acquisition functions may be selected. For example, a Gaussian Process Upper Confidence Bound (GP-UCB) acquisition function may be selected. Alternately, different acquisition functions may be used together as an ensemble learning based approach. The GP-UCB acquisition function is represented as

α_{UCB}=μ(x)+kσ(x) (10):

where k>0 provides a measure of the tradeoff for exploration and exploitation. For example, if k is small, then the emphasis of the acquisition function is on the mean. If k is larger, then the emphasis of the acquisition function is on both the mean and the covariance. As such, k determines how much uncertainty is introduced into the model. The next sample point is determined by optimizing on the acquisition function using (11):

$${x}_{N + 1} = arg {max}_{x ∈ D} α ( x ) , x ∈ {n}^{} \qquad ( 11 )$$

Referring back to the wind turbine example, BO is used to optimize the output of the turbine. The black-box function of the turbine simulation is evaluated to generate the initial sample set of inputs (X=[x₁, . . . , x_{N}]) and corresponding outputs (Y=[y₁, . . . , y_{N}]), with S_{D} denoting (X, Y). The GP is then fit with S_{D}=(X, Y), and the next sampling point xᵢ₊₁ is found with xᵢ₊₁=arg max_{x∈D} acq(x|GP). The black-box function is then evaluated at the next sampling point xᵢ₊₁ and the sample set S_{D} is supplemented with (xᵢ₊₁; yᵢ₊₁). The supplemented sample set S_{D} may used by the GP in a next iteration of the optimization. The iterations are continued until a termination criteria is met.

Depending on the dimensions of the wind turbine simulation (e.g., the multivariate input vectors X), the BO may not efficiently perform the optimization problem. A stacked autoencoder (SAE) is introduced into the GP optimization problem to reduce the dimensions of the input to the GP.

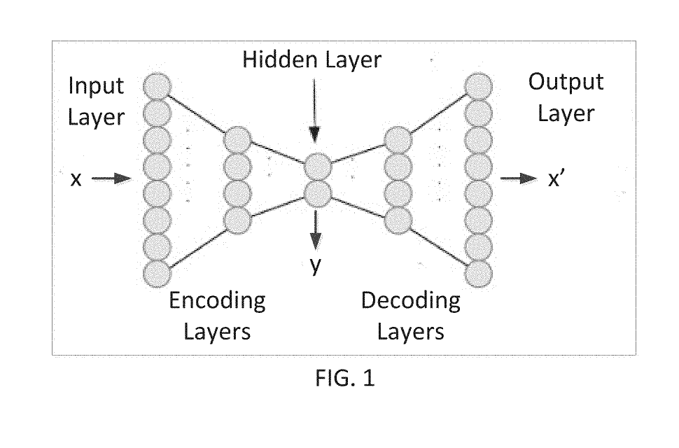

FIG. 1 illustrates a block diagram of an example of an autoencoder. An autoencoder, such as a stacked denoising autoencoder, receives a multivariate input x at an input layer and maps x to a representation z in a bottleneck hidden layer, reducing the dimensions of x. The autoencoder then maps z to x′ the original dimension at the output layer, thus reconstructing the input x from z. The output x′ is an approximate reconstructed output of the input x. The representation z is a transformation of x at lower dimension (e.g., using a contractive autoencoder). If the stacked autoencoder is a denoising autoencoder, noise in the input x is removed by reconstructing a clean output x′ without the noise. In this way, the stacked denoising autoencder is trained to extract the important features from x, ignoring the noise, to be encoded at the hidden layer representation z and for reconstructing a clean output x′. After machine training, the representation z is used as the input to the Bayesian Optimization.

As depicted in FIG. 1, a stacked autoencoder includes multiple input layers for encoding an input to the bottleneck hidden layer and multiple output layers for decoding an output. Each input layer reduces the dimensions of the input by transforming the input into a new input of fewer dimensions. The dimensions of each layer are different from the previous layer (e.g., are not a subset of the dimensions from the previous layer). FIG. 1 depicts a two layer SAE, reducing an eight dimensional input to four dimensions in the first layer, and the four dimensions to two dimensions in the second layer. Additional or fewer layers may be provided to reduce the dimensions of an input and/or to handle higher dimensional inputs.

For example, the encoding layers map the input x (x∈ [symbol] ⁿ) to the hidden layer representation z (x∈ [symbol] ^{p}), where (p<n). The decoding layers decode the hidden representation z into x′ in the original dimensional space [symbol] ⁿ. The stacked autoencoder uses an activation function for encoding the input and decoding the output. For example, a sigmoid activation function is used for the encoder and decoder layers. A sigmoid activation function determines the bounds of the hidden layer in the p dimensional space. The reconstruction error ∥x−x′∥² is minimized using a gradient descent on the parameter space Wᵢ, adjusting the weight of connections between layers of the stacked autoencoder through backpropagation. Other activation functions may be used, such as a tan h function.

The present embodiments provide for using the hidden representation z of the hidden layer of the SAE, at the lower dimension p, as output of a pre-processing step for the BO. For example, with z denoting sample values of an input in the p-dimension (p<n), the input to the BO is represented by (12):

x∈D′⊂ [symbol] ^{p} (12)

with gₐₑ denoting the inverse transformation using the SAE, represented as x=gₐₑ(z). The optimization problem is transformed to a lower dimensional optimization problem as (13-14):

$$\begin{matrix} & ( 13 ) \\ F = f ( \hat{g} ( \cdot ) ) & ( 14 )\end{matrix}$$

Because ƒ is unknown, F(z)=ƒ(g(x)) is also an unknown black-box function. Therefore, the BO-based black-box optimization problem is represented as (15):

$$( 15 )$$

By using a SAE for the input to the BO, the GP of the BO is performed and bounded in the p dimensional space, optimizing the acquisition function with fewer dimensions. Because transformation of the input x to the lower dimension hidden representation z is controlled by a stacked autoencoder, the bounds of the hidden representation in the lower space may still be unknown or impossible to calculate. However, by selecting a particular activation function for the stacked autoencoder, such as a sigmoid or tan h function, the hidden representation z may be bounded. For example, using a sigmoid function, the bounds in the lower space are [0, 1]. Alternatively, using a tan h function, the bounds in the lower space are [−1, 1]. The bounds may not be determined for activation functions that do not have bounded outputs (e.g., Linear, ReLu, etc.).

Referring again back to the wind turbine example, a stacked denoising autoencoder may be used with a BO to optimize the output efficiency of the turbine. The black-box function of the turbine simulation is evaluated to generate the initial sample set of inputs (X=[x₁, . . . , x_{N}]) and corresponding outputs (Y=[y₁, . . . , y_{N}]), with S_{D} denoting (X, Y). A stacked denoising autoencoder is machine trained on X. Using the trained autoencoder, the input layers of the autoencoder (e.g., the encoder part) encode X to generate Z (Z=[z₁, z₂, . . . , z_{N}]), with S_{D}, denoting (Z, Y). The GP is then fit with S_{D′}=(Z, Y), and the next sampling point zᵢ₊₁ is found with zᵢ₊₁=arg max_{z∈D′} acq(z|GP). D′ is bounded by the activation function used (e.g., Sigmoid, Tan h, etc.). The output layers of the trained autoencoder (e.g., the decoder part) decode the next sampling point zᵢ₊₁ to get the next sampling point xᵢ₊₁ in the original dimensional space. The black-box function is then evaluated at the next sampling point xᵢ₊₁ and the sample set S_{D} is supplemented with (xᵢ₊₁; yᵢ₊₁). The supplemented sample set S_{D} may be used by the autoencoder and the GP in a next iteration of the optimization. The iterations are continued until a termination criteria is met.

As such, the present embodiments may alleviate the shortcomings of a Bayesian Optimization at higher dimensions (e.g., more than 10 dimensions). By using a stacked autoencoder on the input to the BO, the Gaussian Process of the BO is fit in a lower dimension, and optimizing the acquisition function is performed at the lower dimension and with reduced bounds than the in the original dimensional space. The present embodiments outperform a BO on high dimensional problems without dimension reduction. As such, the present embodiments may be used in optimization problems with higher dimensions (e.g., in the order of 100).

Accordingly, the present embodiments provide an improvement in operation of the computer-based design platform. For example, using a GP-UCB acquisition function and a squared exponential kernel function, using an SAE with BO reduces the number of iterations required by the BO, or permits the BO to find the maxima or minima of the unknown function. For example, using a 75 dimension Ackley function, the standard BO (i.e., without any dimension reduction) will make very slow progress towards the optimal solution and may not converge on a minimum in reasonable time. Using SAE with BO, the dimensions of the Ackley function may be reduced, such as using a 75 to 50 to 25 dimension stacked autoencoder with a sigmoid function (i.e., the original dimension (75) is reduced to a smaller dimension of 25). The SAE allows the BO to converge faster to the minimum and within 50 iterations, reaching a close vicinity of the global minimum of the Ackley function (note: the Ackley function is a standard benchmark, used frequently in the academic and industrial world, for testing the efficiency of global optimization methods and BO methods). Therefore, the computational expense is greatly reduced, improving the efficiency of the computer/processor.

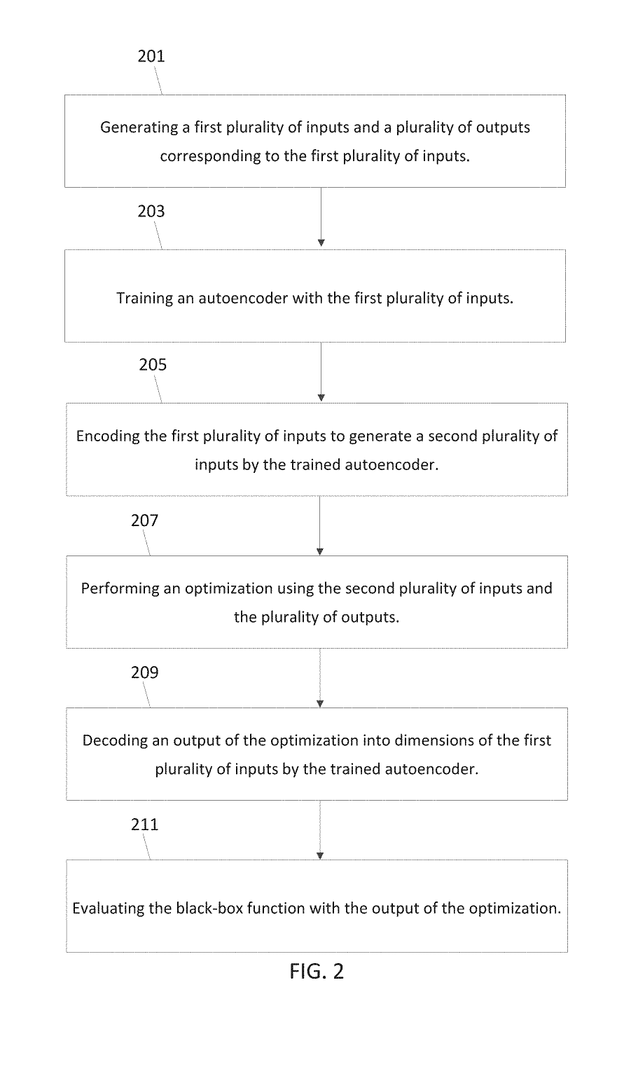

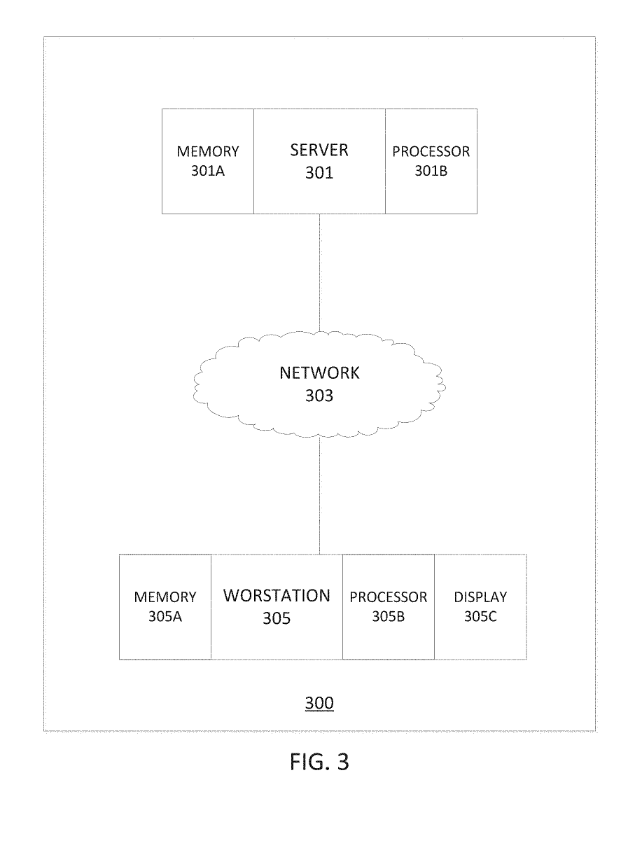

FIG. 2 illustrates a flowchart diagram of an embodiment of a method for reducing dimensions of an input in a black-box optimization. The method is implemented by the system of FIG. 3 (discussed below) and/or a different system. Additional, different or fewer acts may be provided. For example, acts 201, 203 and 211 may be omitted if a plurality of inputs and a trained parameters of the autoencoder are received. The method is provided in the order shown. Other orders may be provided and/or acts may be repeated. For example, acts 205-211 may be repeated for a plurality of iterations generating multiple optimized sampling points.

At act 201, a first plurality of inputs and a plurality of outputs are generated by evaluating a black-box function. The inputs and outputs are generated as pairs, with the each output corresponding to one of the first plurality of inputs. For example, when optimizing the output efficiency of a wind turbine, many variables (e.g., shape at each point in a mesh representing the blade, overall size, material options, rotational speed, rotor radius, wind speed ranges, thickness of blade, noise emissions, lift and drag forces, airfoil shape, etc.) related to the size and shape of the turbine blade are simulated. A function is not easily fit to the simulation, therefore the function defining the simulation is treated as a black-box, with the inputs and corresponding outputs used for optimizing the variables related to the turbine blade. The plurality of inputs are represented as multiple-dimensional vectors, with each dimension representative of a variable related to the size and/or shape of the turbine blade. In the turbine example, the input vectors may include more variables than can be handled by a BO, such as 100 or more dimensions. As discussed above, BO often cannot handle more than 10 dimensions. The corresponding outputs are single-dimensional vectors representing the output efficiency of the wind turbine.

At act 203, an autoencoder is machine trained with the first plurality of inputs. For example, the autoencoder is a stacked denoising autoencoder. Other autoencoders may be used. Other deep learning may be used to derive a representative feature with reduced dimensionality than the input feature. As discussed above, the autoencoder includes a plurality of layers for reducing the dimension of an input. For example, FIG. 1 depicts an autoencoder with two layers. More layers may be included based on a desired final dimension, further reducing the dimension of the input at the expense of the hidden layer accurately representing the original input. The fewer layers, the more dimensions that are included and the more accurately the hidden layer represents the input. Further, using a denoising autoencoder, a noisy input may be reconstructed into a clean output, training the hidden layer to extract the important features representing the black-box function based on the input values.

At act 205, using the trained autoencoder, the first plurality of inputs is encoded to generate a second plurality of inputs. The second plurality of inputs are encoded at the hidden layer representation. The second plurality of inputs are multiple-dimensional vectors, with fewer dimensions than the first plurality of inputs. The dimensions of the second plurality of inputs are different from any of the dimensions of the first plurality of inputs, such as by applying a transformation to the input vectors.

For example, encoding the first plurality of inputs comprises applying layers of non-linear transformations to the first plurality of inputs to generate the second plurality of inputs. Each layer of the autoencoder applies an additional non-linear transformation to an output of the previous layer, thereby further reducing the dimensionality of the first plurality of inputs. As discussed above, applying the layers of non-linear transformations to the first plurality of inputs generates new, different dimensions at each layer, resulting the second plurality of inputs having different dimensions from the first plurality of inputs.

At act 207, an optimization is performed using the second plurality of inputs and the plurality of outputs. Referring back to the wind turbine example, the second plurality of inputs represents features of the first input plurality of inputs with fewer dimensions. A Bayesian Optimization is performed using the second plurality of inputs and the corresponding outputs of the black-box simulation. As discussed above, the BO uses a Gaussian Process to determine an optimized or next sampling point. For example, depending on the optimization problem, the next sampling point is a maxima or minima of the unknown black-box function. The output efficiency of a wind turbine may be a maxima, therefore the next sampling point is an optimized multivariate input vector in the reduced dimensional space corresponding to a maximized output of the black-box simulation.

At act 209, an output of the optimization is decoded by the trained autoencoder into dimensions of the first plurality of inputs. As discussed above, the output of the optimization is an optimized or next sampling point for the black-box simulation. The next sampling point is determined at a lower, different dimensional space than the original input values. The next sampling point is decoded to the original dimensional space, increasing the dimensions of the sampling point to the original input dimension. In the wind turbine example, the decoded sampling point is a multivariate input vector associated with an optimized output. The decoded optimal or next sampling point includes optimized variables for the size and shape of the turbine blade.

At act 211, the black-box function is evaluated with the output of the optimization. For example, the black-box function is evaluated with the decoded optimal or next sampling point. In the wind turbine example, the decoded next sampling point is another multivariate input vector including parameters for the size and shape of the blade to be evaluated using the black-box simulation. Based on the output of the simulation, additional iterations of the optimization may be performed, including the new input and output pair from the previous iteration. The process concludes when a termination criteria is met, such as a desired output efficiency of the wind turbine.

The optimized parameters of the blade of wind turbine may be displayed to the user, or incorporated in design of other aspects of the wind turbine. For example, the parameters may be used to generate design specifications and/or computer-aided design (CAD) drawings of the turbine. Further, the optimized parameters of the wind turbine may be used to manufacture and/or install the wind turbine.

FIG. 3 illustrates an embodiment of a system for reducing dimensions of an input in an optimization. The system 300 allows for reducing the dimensions of the input and/or performing the optimization by one or both of a remote workstation 305 and a server 301. The system 300 may be provided as part of a cloud-based or local software-based engineering design platform, and may include one or more server 301, one or more network 303 and/or one or more workstation 305. Additional, different, or fewer components may be provided. For example, additional servers 301, networks 303 and/or workstations 305 may be used. In another example, the server 301 and the workstation 305 are directly connected, or implemented on a single computing device.

The server 301 and/or workstation 305 is a computer platform having hardware such as one or more central processing units (CPU), a system memory, a random access memory (RAM) and input/output (I/O) interface(s). Additional, different or fewer components may be provided. For example, the server 301 includes a memory 301A and the workstation 305 includes a memory 305A. The memory 301A and/or 305A store a plurality of input/output pairs for an unknown function (e.g., input vectors and a corresponding outputs). The server 301 includes a processor 301B and the workstation 305 includes a processor 305B. The processor 301B and/or 305B are configured to receive the input/output pairs from the memory 301A and/or 305A, and to perform an optimization of the unknown function. For example, the plurality of input vectors and the plurality of outputs are received, and using a stacked autoencoder, a dimensional space of the plurality of input vectors is reduced. A Bayesian Optimization is performed based on the reduced dimensional space of the plurality of input vectors and the plurality of outputs, and the output of the BO is a new sampling point. The BO includes a Gaussian Process for generating a probabilistic model of the unknown function at the reduced dimensional space. Using the stacked autoencoder, an output of the BO is projected into the original dimensional space of the plurality of input vectors and the unknown function is evaluated using the output in the original dimensional space of the plurality of input vectors. The plurality of input vectors and the plurality of outputs are updated to include an input vector and an output for the evaluated sampling point. Further, the workstation 305 may include a display 305C for displaying the output to a user (e.g., the optimized parameters of the output of the optimization, etc.).

The system 300 also includes one or more networks 303. The network 303 is a wired or wireless network, or a combination thereof. Network 303 is configured as a local area network (LAN), wide area network (WAN), intranet, Internet or other now known or later developed network configurations. Any network or combination of networks for communicating between the server 301, the workstation 305 and other components may be used.

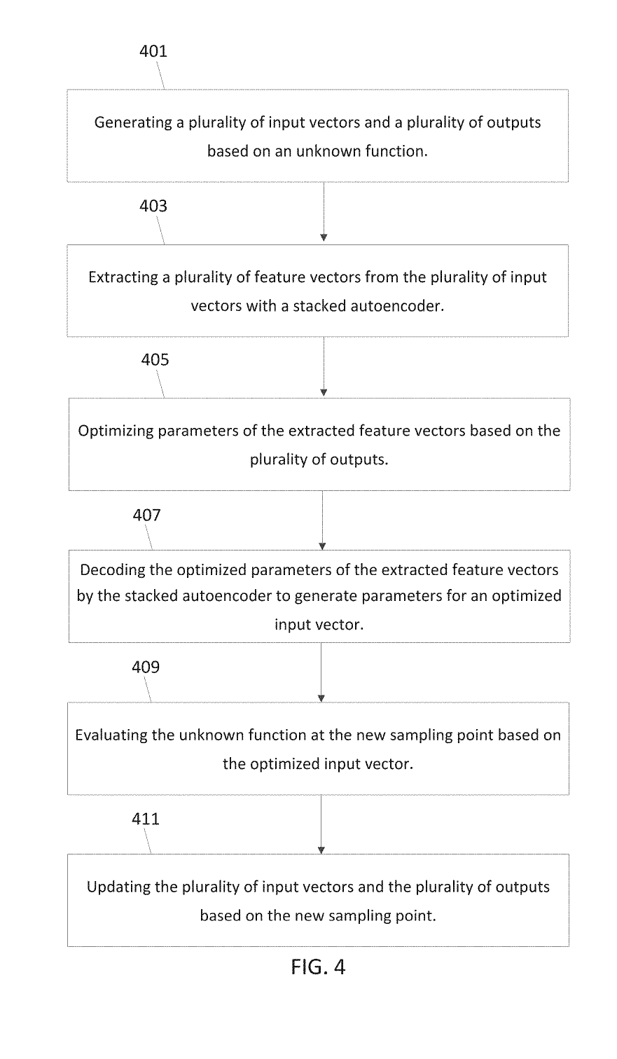

FIG. 4 illustrates a flowchart diagram of an embodiment of a method for reducing input dimensions for optimizing an unknown function. The method is implemented by the system of FIG. 3 and/or a different system. Additional, different or fewer acts may be provided. For example, the acts 401, 409 and 411 may be omitted. The method is provided in the order shown. Other orders may be provided and/or acts may be repeated. For example, acts 403-411 may be repeated to perform additional iterations of the optimization.

At act 401, a plurality of input vectors and a plurality of outputs are generated based on an unknown function. For example, generating the plurality of input vectors and the plurality of outputs comprises sparsely sampling the unknown function. For example, it may not be feasible to construct a lower dimensional representation of the complete original dimensional space of the unknown function, such as using continuous function analysis. Bayesian Optimization may rely on sparse samples of the original dimensional space to optimize parameters of the unknown function. The original dimensional space is sparsely sampled to generate the plurality of input vectors and corresponding outputs.

At act 403, a plurality of feature vectors are extracted from the plurality of input vectors using a stacked autoencoder. The extracted feature vectors are represented by fewer dimensions than the input vectors. As discussed above, the original dimensional space is sparsely sampled to generate the plurality of input vectors and corresponding outputs. The input vectors are used to train the stacked autoencoder in advance of the optimization to extract features from the input vectors. There is no need to train the stacked autoencoder on the entire original dimensional space, thus only the sparse samples in the generated input vectors are used. After machine training, a hidden representation (e.g., feature vectors) are encoded using the stacked autoencoder for use as an input to the optimization. When the feature vectors are encoded, a plurality on non-linear transformations are applied to the input vectors, with each non-linear transformation applied in a different layer of the stacked autoencoder.

At act 405, the parameters of the extracted feature vectors are optimized based on the plurality of outputs from the unknown function. For example, optimizing parameters of the extracted feature vectors comprises performing a Bayesian Optimization. As discussed above, performing the Bayesian Optimization includes a Gaussian Process that generates a probabilistic model for the unknown function based on the plurality of outputs. Other optimizations may be used to optimize the extracted features from the stacked autoencoder.

At act 407, the optimized parameters of the extracted feature vectors are decoded by the stacked autoencoder to generate parameters for an optimized input vector. For example, the generated parameters for the optimized input vector represent a new sampling point for the unknown function and/or optimized parameters for an input to the unknown function. At act 409, the unknown function is evaluated at the new sampling point. At act 411, updating the plurality of input vectors and the plurality of outputs are updated based on evaluating of the new sampling point.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

We claim:

1. A method for reducing dimensions of an input in a black-box and simulation-based optimization, the method comprising:
generating, by evaluating a black-box function characterizing an equipment component, a first plurality of inputs and a plurality of outputs corresponding to the first plurality of inputs;
encoding, by a machine-trained autoencoder, the first plurality of inputs to generate a second plurality of inputs, wherein the second plurality of inputs comprises fewer dimensions than the first plurality of inputs;
performing an optimization using the second plurality of inputs and the plurality of outputs;
decoding, by the machine-trained autoencoder, an output of the optimization into dimensions of the first plurality of inputs.

2. The method of claim 1, wherein the first plurality of inputs and the second plurality of inputs are multiple-dimensional vectors, and wherein the plurality of outputs are single-dimensional vectors.

3. The method of claim 1, wherein encoding the first plurality of inputs comprises applying layers of non-linear transformations to the first plurality of inputs to generate the second plurality of inputs.

4. The method of claim 3, wherein applying the layers of non-linear transformations to the first plurality of inputs generates new dimensions for the second plurality of inputs, wherein the new dimensions of the second plurality of inputs are different from dimensions of the first plurality of inputs.

5. The method of claim 1, wherein the autoencoder is a stacked denoising autoencoder.

6. The method of claim 1, wherein the optimization is a Bayesian optimization.

7. The method of claim 1, the output of the Bayesian optimization is a sampling point.

8. The method of claim 7, further comprising:
evaluating the black-box function at the decoded sampling point.

9. A system for reducing dimensions of an input in an optimization, the system comprising:
a memory configured to store a plurality of input vectors and a plurality of outputs for an unknown function that characterizes requirements for equipment design; and
a processor configured to:
receive, from the memory, the plurality of input vectors and the plurality of outputs;
reduce, with a machine-learnt stacked autoencoder, a dimensional space of the plurality of input vectors;
perform a Bayesian optimization based on the reduced dimensional space of the plurality of input vectors and the plurality of outputs;
project, with the stacked autoencoder, an output of the Bayesian optimization into the dimensional space of the plurality of input vectors.

10. The system of claim 9, wherein the output of the Bayesian optimization is a sampling point.

11. The system of claim 10, wherein the processor if further configured to:
evaluate the unknown function at the sampling point projected into the dimensional space of the plurality of input vectors.

12. The system of claim 11, wherein the processor if further configured to:
update the plurality of input vectors and the plurality of outputs for an unknown function with an input vector and an output for the evaluated sampling point.

13. The method of claim 9, wherein the Bayesian optimization comprises a Gaussian process to generate a probabilistic model of the unknown function at the reduced dimensional space.

14. A method for reducing input dimensions for optimizing an unknown function, the method comprising:
generating a plurality of input vectors and a plurality of outputs based on an unknown function characterizing an equipment component;
extracting, with a machine-learnt stacked autoencoder, a plurality of feature vectors from the plurality of input vectors, wherein the feature vectors are represented by fewer dimensions than the input vectors;
optimizing parameters of the extracted feature vectors based on the plurality of outputs;
decoding, by the stacked autoencoder, the optimized parameters of the extracted feature vectors to generate parameters for an optimized input vector.

15. The method of claim 14, wherein extracting the plurality of feature vectors comprises applying a plurality on non-linear transformations, each non-linear transformation comprising one of a plurality of layers of the stacked autoencoder.

16. The method of claim 14, wherein generating the plurality of input vectors and the plurality of outputs comprises sparsely sampling the unknown function.

17. The method of claim 14, wherein optimizing parameters of the extracted feature vectors comprises performing a Bayesian optimization.

18. The method of claim 17, wherein performing the Bayesian optimization comprises a Gaussian process generating a probabilistic model for the unknown feature vectors based on the plurality of outputs.

19. The method of claim 14, wherein the generated parameters for the optimized input vector comprise a new sampling point for the unknown function.

20. The method of claim 19, further comprising:
evaluating the unknown function at the new sampling point; and
updating the plurality of input vectors and the plurality of outputs based on the new sampling point.
